(19) United States
(12) Patent Application Publication
(10) Pub. No.: US 2020/0388913 A1
(43) Pub. Date: Dec. 10, 2020

(54) DISPLAY INTEGRATABLE HYBRID TRANSPARENT ANTENNA

(71) Applicant: Apple Inc., Cupertino, CA (US)

(72) Inventors: Mei Chai, Marietta, GA (US); Bryce D. Horine, Portland, OR (US); Harry G. Skinner, Beaverton, OR (US); Tae-Young Yang, Portland, OR (US)

(21) Appl. No.: 16/766,736

(22) PCT Filed: Nov. 19, 2018
(86) PCT No.: PCT/US2018/061801

§ 371 Date: May 25, 2020

Related U.S. Application Data
(60) Provisional application No. 62/590,987, filed on Nov. 27, 2017.

(51) Int. Cl. H01Q 1/44; G06F 3/041; H01Q 9/04; H01Q 21/28

(52) U.S. Cl. CPC H01Q 1/44; G06F 3/041; H01Q 5/40; H01Q 21/28; H01Q 9/0407

(57) ABSTRACT

An apparatus for a wireless device includes a radio front end module (RFEM) configured to generate radio frequency (RF) signals. The apparatus further includes a multi-layer display, including a liquid crystal display (LCD) layer, a touch panel layer, and a cover glass layer. The apparatus further includes an antenna configured to transmit the RF signals. The antenna includes a primary coupling feeding structure, configured to receive the RF signals from the radio front end module via a feed line. The antenna also includes a generating structure configured to radiate the RF signals. The generating structure is alternating current (AC) operably coupled to the primary coupling feeding structure and is within a visible portion of the multi-layer display. The primary coupling feeding structure can include a non-transparent material and is disposed in a non-visible area of the cover glass layer.

### PRIORITY CLAIM

This application claims the benefit of priority to U.S. Provisional Patent Application Ser. No. 62/590,987, filed Nov. 27, 2017, and entitled “DISPLAY INTEGRATABLE HYBRID TRANSPARENT ANTENNA,” which provisional patent applications is incorporated herein by reference in its entirety.

### TECHNICAL FIELD

Aspects described herein relate generally to methods and apparatuses for wireless communication. More particularly, aspects relate to antennas and antenna structures. Some aspects of the present disclosure pertain to display integratable antennas and antenna structures. Some aspects of the present disclosure pertain to wireless communication devices (e.g., wearable devices and other computing devices with a predominant display feature, such as mobile devices with touch-enabled display or another type of display). Some aspects of the present disclosure relate to display integratable hybrid transparent antennas, e.g., as used in wearable or other portable devices.

### BACKGROUND

Today's wireless systems (smart watches or other devices with a predominant display feature, for example) are striving to achieve an edge-to-edge display with a smaller bezel or bezel-less display solution. Especially for wearable devices, such as smart watches, smart glasses, or smart health-related monitoring devices (e.g., devices that can monitor health-related data, such as heartbeat arrhythmia, blood pressure, pulse, calories burned during a physical activity, and so forth), the display is small and the number of wireless radios (e.g., Bluetooth, GPS, WiFi, 3G/4G/LTE, FM, and so forth) that need to be supported and the related antennas is increasing. Antenna solutions for such devices can be challenging.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various aspects discussed in the present document.

FIG. 1 is a block diagram of an example radio architecture in accordance with some aspects of the present disclosure;

FIG. 2 illustrates an exemplary front-end module circuitry for use in the radio architecture of FIG. 1 in accordance with some aspects of the present disclosure;

FIG. 3 illustrates a radio IC circuitry for use in the radio architecture of FIG. 1 in accordance with some aspects of the present disclosure;

FIG. 4 illustrates a baseband processing circuitry for use in the radio architecture of FIG. 1 in accordance with some aspects of the present disclosure;

FIG. 5 illustrates an example display stack-up in accordance with some aspects.

FIG. 6 illustrates touch sensor traces of a touch panel layer of a device display in accordance with some aspects.

FIG. 7 illustrates touch sensor traces of a touch panel layer in accordance with some aspects.

FIG. 8 illustrates a display stack-up with integrated antenna solutions in accordance with some aspects.

FIG. 9 illustrates example antenna feeding and generating structures in accordance with some aspects.

FIG. 10 illustrates a block diagram of a communication device in accordance with some aspects.

### DETAILED DESCRIPTION

The following description and the drawings sufficiently illustrate aspects to enable those skilled in the art to practice them. Other aspects may incorporate structural, logical, electrical, process, and other changes. Portions and features of some aspects may be included in, or substituted for, those of other aspects. Aspects set forth in the claims encompass all available equivalents of those claims.

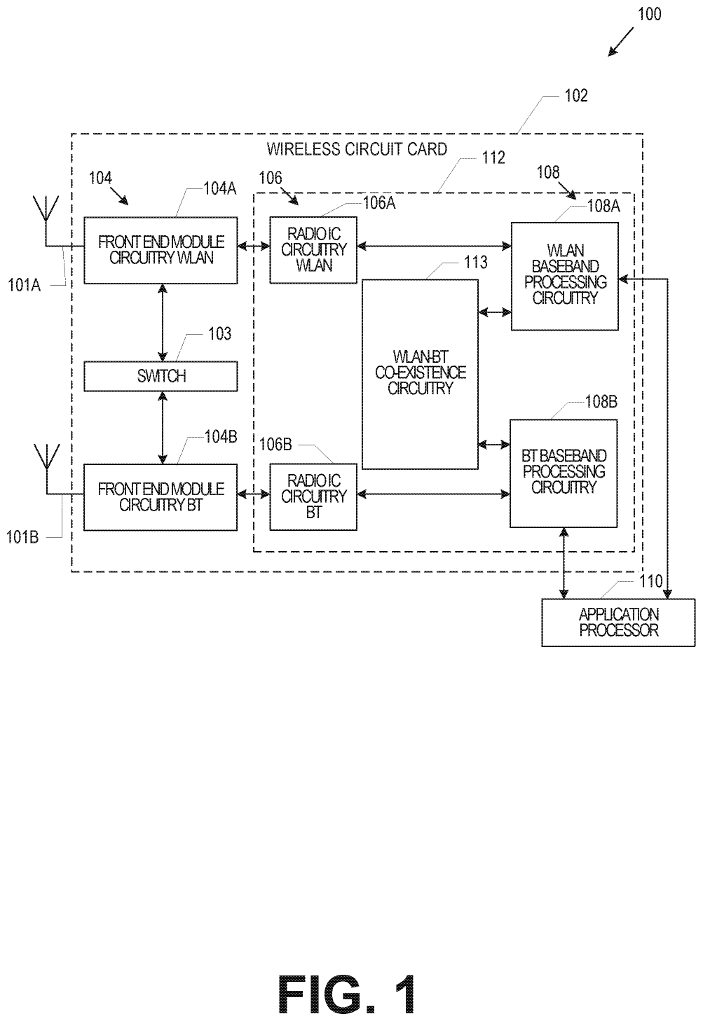

FIG. 1 is a block diagram of an example radio architecture 100 in accordance with some aspects of the present disclosure. Radio architecture 100 may include radio front-end module (FEM) circuitry 104, radio IC circuitry 106 and baseband processing circuitry 108. Radio architecture 100 as shown includes both Wireless Local Area Network (WLAN) functionality and Bluetooth (BT) functionality although aspects of the disclosure are not so limited. In this disclosure, “WLAN” and “Wi-Fi” are used interchangeably.

FEM circuitry 104 may include a WLAN or Wi-Fi FEM circuitry 104A and a Bluetooth (BT) FEM circuitry 104B. The WLAN FEM circuitry 104A may include a receive signal path comprising circuitry configured to operate on WLAN RF signals received from one or more antennas 101A, to amplify the received signals and to provide the amplified versions of the received signals to the WLAN radio IC circuitry 106A for further processing. The BT FEM circuitry 104B may include a receive signal path which may include circuitry configured to operate on BT RF signals received from one or more antennas 101B, to amplify the received signals and to provide the amplified versions of the received signals to the BT radio IC circuitry 106B for further processing. FEM circuitry 104A may also include a transmit signal path which may include circuitry configured to amplify WLAN signals provided by the radio IC circuitry 106A for wireless transmission by one or more of the antennas 101A. In addition, FEM circuitry 1049 may also include a transmit signal path which may include circuitry configured to amplify BT signals provided by the radio IC circuitry 106B for wireless transmission by the one or more antennas 101B. In the example of FIG. 1, although FEM 104A and FEM 104B are shown as being distinct from one another, aspects of the present disclosure are not so limited, and include within their scope the use of an FEM (not shown) that includes a transmit path and/or a receive path for both WLAN and BT signals, or the use of one or more FEN circuitries where at least some of the FEM circuitries share transmit and/or receive signal paths for both WLAN and BT signals.

Radio IC circuitry 106 as shown may include WLAN radio IC circuitry 106A and BT radio IC circuitry 106B. The WLAN radio IC circuitry 106A may include a receive signal path which may include circuitry to down-convert WLAN RF signals received from the FEM circuitry 104A and provide baseband signals to WLAN baseband processing circuitry 108A. BT radio IC circuitry 106B may in turn include a receive signal path which may include circuitry to down-convert BT RF signals received from the FEM circuitry 104B and provide baseband signals to BT baseband processing circuitry 108B. WLAN radio IC circuitry 106A may also include a transmit signal path which may include circuitry to up-convert WLAN baseband signals provided by the WLAN baseband processing circuitry 108A and provide WLAN RF output signals to the FEM circuitry 104A for subsequent wireless transmission by the one or more antennas 101A. BT radio IC circuitry 106B may also include a transmit signal path which may include circuitry to up-convert BT baseband signals provided by the BT baseband processing circuitry 108B and provide BT RF output signals to the FEM circuitry 104B for subsequent wireless transmission by the one or more antennas 101B. In the example of FIG. 1, although radio IC circuitries 106A and 106B are shown as being distinct from one another, aspects of the present disclosure are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

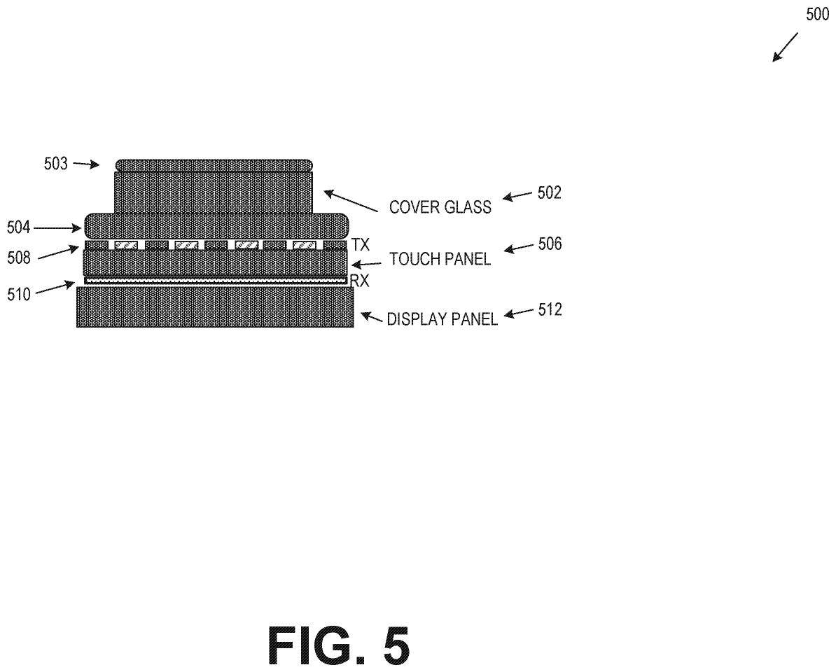

In an example, the radio IC circuitry 106 can include one or more divider-less fractional phase locked loops (PLLs) for generating fractional frequency signals, such as signals with frequencies that are a fraction of a frequency of a reference signal. Further description of example divider-less fractional PLLs is provided herein in reference to FIGS. 5-10.

Baseband processing circuitry 108 may include a WLAN baseband processing circuitry 108A and a BT baseband processing circuitry 108B. The WLAN baseband processing circuitry 108A may include a memory, such as, for example, a set of RAM arrays in a Fast Fourier Transform or Inverse Fast Fourier Transform block (not shown) of the WLAN baseband processing circuitry 108A. Each of the WLAN baseband circuitry 108A and the BT baseband circuitry 108B may further include one or more processors and control logic to process the signals received from the corresponding WLAN or BT receive signal path of the radio IC circuitry 106, and to also generate corresponding WLAN or BT baseband signals for the transmit signal path of the radio IC circuitry 106. Each of the baseband processing circuitries 108A and 108B may further include physical layer (PHY) and medium access control layer (MAC) circuitry, and may further interface with application processor 110 for generation and processing of the baseband signals and for controlling operations of the radio IC circuitry 106.

Referring still to FIG. 1, according to the illustrated aspects, WLAN-BT coexistence circuitry 113 may include logic providing an interface between the WLAN baseband circuitry 108A and the BT baseband circuitry 108B to enable use cases requiring WLAN and BT coexistence. In addition, a switch 103 may be provided between the WLAN FEM circuitry 104A and the BT FEM circuitry 104B to allow switching between the WLAN and BT radios according to application needs. In addition, although the antennas 101A, 101B are depicted as being respectively connected to the WLAN FEM circuitry 104A and the BT FEM circuitry 104B, aspects of the present disclosure include within their scope the sharing of one or more antennas as between the WLAN and BT FEMs, or the provision of more than one antenna connected to each of FEM 104A or 104B.

In some aspects of the present disclosure, the front-end module circuitry 104, the radio IC circuitry 106, and baseband processing circuitry 108 may be provided on a single radio card, such as wireless radio card 102. In some other aspects of the present disclosure, the one or more antennas 101A, 101B, the FEM circuitry 104 and the radio IC circuitry 106 may be provided on a single radio card. In some other aspects of the present disclosure, the radio IC circuitry 106 and the baseband processing circuitry 108 may be provided on a single chip or integrated circuit (IC), such as IC 112.

In some aspects of the present disclosure, the wireless radio card 102 may include a WLAN radio card and may be configured for Wi-Fi communications, although the scope of the aspects of the present disclosure is not limited in this respect. In some of these aspects of the present disclosure, the radio architecture 100 may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier aspects of the present disclosure, radio architecture 100 may be part of a Wi-Fi communication station (STA) such as a wireless access point (AP), a base station, a mobile device, or a wearable device including a Wi-Fi device. In some of these aspects of the present disclosure, radio architecture 100 may be configured to transmit and receive signals in accordance with specific communication standards and/or protocols, such as any of the Institute of Electrical and Electronics Engineers (I FEE) standards including, IEEE 802.11n-2009, IEEE 802.11-2016, IEEE 802.11n-2009, IEEE 802.11ac, and/or WEE 802.11ax standards and/or proposed specifications for WLANs, although the scope of aspects of the present disclosure is not limited in this respect. Radio architecture 100 may also be suitable to transmit and/or receive communications in accordance with other techniques and standards.

In some aspects of the present disclosure, the radio architecture 100 may be configured for high-efficiency (HE) Wi-Fi (HEW) communications in accordance with the IEEE 802.11ax standard. In these aspects of the present disclosure, the radio architecture 100 may be configured to communicate in accordance with an OFDMA technique, although the scope of the aspects of the present disclosure is not limited in this respect.

In some other aspects of the present disclosure, the radio architecture 100 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the aspects of the present disclosure is not limited in this respect.

In some aspects of the present disclosure, as further shown in FIG. 1, the BT baseband circuitry 108B may be compliant with a Bluetooth (BT) connectivity standard such as Bluetooth, Bluetooth 4.0 or Bluetooth 5.0, or any other iteration of the Bluetooth Standard. In aspects of the present disclosure that include BT functionality as shown for example in FIG. 1, the radio architecture 100 may be configured to establish a BT synchronous connection oriented (SCO) link and/or a BT low energy (BT LE) link. In some of the aspects of the present disclosure that include functionality, the radio architecture 100 may be configured to establish an extended SCO (eSCO) link for BT communications, although the scope of the aspects of the present disclosure is not limited in this respect. In some of these aspects of the present disclosure that include a BT functionality, the radio architecture may be configured to engage in a BT Asynchronous Connection-Less (ACL) communications, although the scope of the aspects of the present disclosure is not limited in this respect. In some aspects of the present disclosure, as shown in FIG. 1, the functions of a BT radio card and WLAN radio card may be combined on a single wireless radio card, such as single wireless radio card 102, although aspects of the present disclosure are not so limited, and include within their scope discrete WLAN and BT radio cards

In some aspects of the present disclosure, the radio-architecture 100 may include other radio cards, such as a cellular radio card configured for cellular (e.g., 3GPP such as LTE, LTE-Advanced or 5G communications).

In some IEEE 802.11 aspects of the present disclosure, the radio architecture 100 may be configured for communication over various channel bandwidths including bandwidths having center frequencies of about 900 MHz, 2.4 GHz, 5 GHz, and bandwidths of about 1 MHz, 2 MHz, 2.5 MHz, 4 MHz, 5 MHz, 8 MHz, 10 MHz, 16 MHz, 20 MHz, 40 MHz, 80 MHz (with contiguous bandwidths) or 80+80 MHz (160 MHz) (with non-contiguous bandwidths). In some aspects of the present disclosure, a 320 MHz channel bandwidth may be used. The scope of the aspects of the present disclosure is not limited with respect to the above center frequencies however.

In some aspects, the wireless card 102 can be implemented as part of a portable wireless device with a predominant display feature, such as a wearable device (e.g., a smart watch with wireless communication capabilities). In this regard, the illustrated antennas 101A, 101E can be implemented using one or more of the techniques disclosed herein. As used herein, the term “predominant display feature” refers to a touch-enabled display or another type of display within a computing device.

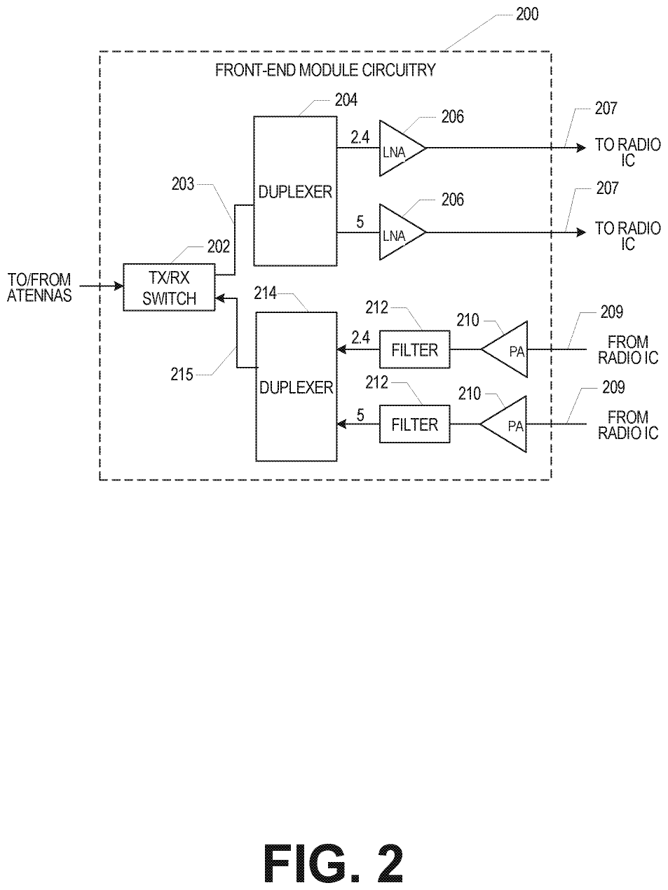

FIG. 2 illustrates FEM circuitry 200, in accordance with some aspects of the present disclosure. The FEM circuitry 200 is one example of circuitry that may be suitable for use as the WLAN and/or BT FEM circuitry 104A/104B (FIG. 1), although other circuitry configurations may also be suitable.

In some aspects of the present disclosure, the FEM circuitry 200 may include a TX/RX switch 202 to switch between transmit mode and receive mode operation. The FEM circuitry 200 may include a receive signal path and a transmit signal path. The receive signal path of the FEM circuitry 200 may include a low-noise amplifier (LNA) 206 to amplify received RF signals 203 and provide the amplified received RF signals 207 as an output (e.g., to the radio IC circuitry 106 (FIG. 1)). The transmit signal path of the circuitry 200 may include a power amplifier (PA) 210 to amplify input RF signals 209 (e.g., provided by the radio IC circuitry 106), and one or more filters 212, such as band-pass filters (BPFs), low-pass filters (LPFs) or other types of filters, to generate RF signals 215 for subsequent transmission (e.g., by one or more of the antennas 101A, 101B (FIG. 1)).

In some dual-mode aspects of the present disclosure for Wi-Fi communication, the FEM circuitry 200 may be configured to operate in either the 2.4 GHz frequency spectrum or the 5 GHz frequency spectrum. In these aspects of the present disclosure, the receive signal path of the FEM circuitry 200 may include a receive signal path duplexer 204 to separate the signals from each spectrum as well as provide a separate LNA 206 for each spectrum as shown. In these aspects of the present disclosure, the transmit signal path of the FEM circuitry 200 may also include a power amplifier 210 and a filter 212, such as a BPF, a LPF or another type of filter for each frequency spectrum and a transmit signal path duplexer 214 to provide the signals of one of the different spectrums onto a single transmit path for subsequent transmission by the one or more of the antennas 101A, 101B (FIG. 1). In some aspects of the present disclosure, BT communications may utilize the 2.4 GHZ signal paths and may utilize the same FEM circuitry 200 as the one used for WLAN communications.

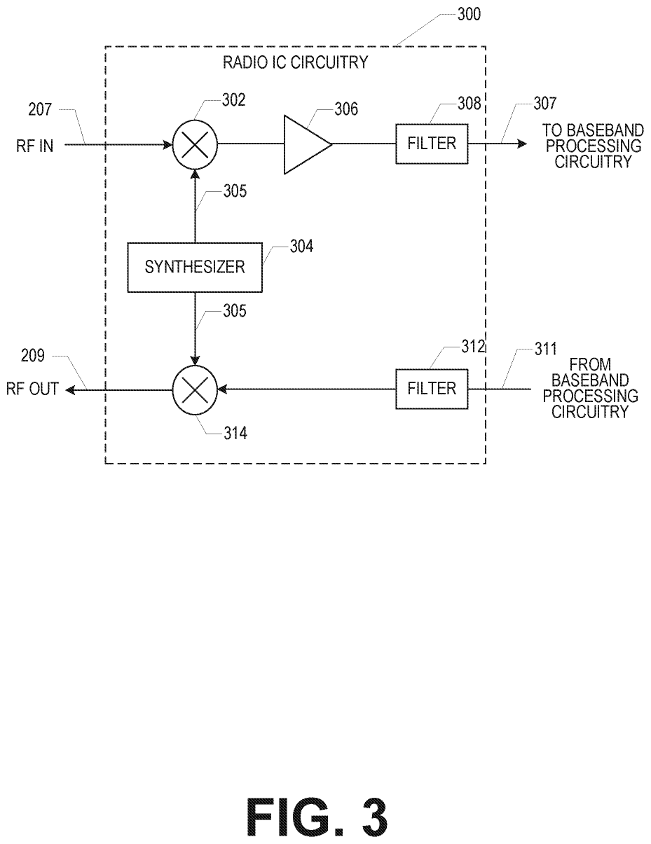

FIG. 3 illustrates radio IC circuitry 300 in accordance with some aspects of the present disclosure. The radio IC circuitry 300 is one example of circuitry that may be suitable for use as the WLAN or BT radio IC circuitry 106A/106B (FIG. 1), although other circuitry configurations may also be suitable.

In some aspects of the present disclosure, the radio IC circuitry 300 may include a receive signal path and a transmit signal path. The receive signal path of the radio IC circuitry 300 may include at least mixer circuitry 302, such as, for example, down-conversion mixer circuitry, amplifier circuitry 306 and filter circuitry 308. The transmit signal path of the radio IC circuitry 300 may include at least filter circuitry 312 and mixer circuitry 314, such as, for example, up-conversion mixer circuitry. Radio IC circuitry 300 may also include synthesizer circuitry 304 for synthesizing a frequency 305 for use by the mixer circuitry 302 and the mixer circuitry 314. The mixer circuitry 302 and/or 314 may each, according to some aspects of the present disclosure, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 3 illustrates only a simplified version of a radio IC circuitry, and may include, although not shown, aspects of the present disclosure where each of the depicted circuitries may include more than one component. For instance, mixer circuitry 302 and/or 314 may each include one or more mixers, and filter circuitries 308 and/or 312 may each include one or more filters, such as one or more BPFs and/or LPFs according to application needs. For example, when mixer circuitries are of the direct-conversion type, they may each include two or more mixers.

In some aspects of the present disclosure, mixer circuitry 302 may be configured to down-convert RF signals 207 received from the FEIN circuitry 104 (FIG. 1) based on the synthesized frequency 305 provided by synthesizer circuitry 304. The amplifier circuitry 306 may be configured to amplify the down-converted signals and the filter circuitry 308 may include a LPF configured to remove unwanted signals from the down-converted signals to generate output baseband signals 307. Output baseband signals 307 may be provided to the baseband processing circuitry 108 (FIG. 1) for further processing. In some aspects of the present disclosure, the output baseband signals 307 may be zero-frequency baseband signals, although this is not a requirement. In some aspects of the present disclosure, mixer circuitry 302 may comprise passive mixers, although the scope of the aspects of the present disclosure is not limited in this respect.

In some aspects of the present disclosure, the mixer circuitry 314 may be configured to up-convert input baseband signals 311 based on the synthesized frequency 305 provided by the synthesizer circuitry 304 to generate RF output signals 209 for the FELT circuitry 104. The baseband signals 311 may be provided by the baseband processing circuitry 108 and may be filtered by filter circuitry 312. The filter circuitry 312 may include a LPF or a BPF, although the scope of the aspects of the present disclosure is not limited in this respect.

In some aspects of the present disclosure, the mixer circuitry 302 and the mixer circuitry 314 may each include two or more mixers and may be arranged for quadrature down-conversion and/or up-conversion respectively with the help of synthesizer 304. In some aspects of the present disclosure, the mixer circuitry 302 and the mixer circuitry 314 may each include two or more mixers each configured for image rejection (e.g., Hartley image rejection). In some aspects of the present disclosure, the mixer circuitry 302 and the mixer circuitry 314 may be arranged for direct down-conversion and/or direct up-conversion, respectively. In some aspects of the present disclosure, the mixer circuitry 302 and the mixer circuitry 314 may be configured for super-heterodyne operation, although this is not a requirement.

Mixer circuitry 302 may comprise, according to one aspect, quadrature passive mixers (e.g., for the in-phase (I) and quadrature phase (Q) paths). In such aspect, RF input signal 207 from FIG. 3 may be down-converted to provide I and Q baseband output signals to be sent to the baseband processor

Quadrature passive mixers may be driven by zero and ninety-degree time-varying LO switching signals provided by a quadrature circuitry which may be configured to receive a LO frequency (fLO) from a local oscillator or a synthesizer, such as LO frequency 305 of synthesizer 304 (FIG. 3). In some aspects of the present disclosure, the LO frequency may be the carrier frequency, while in other aspects of the present disclosure, the LO frequency may be a fraction of the carrier frequency (e.g., one-half the carrier frequency, one-third the carrier frequency), generated by, e.g., fractional PLL circuitry. In some aspects of the present disclosure, the zero and ninety-degree time-varying switching signals may be generated by the synthesizer, although the scope of the aspects of the present disclosure is not limited in this respect.

In some aspects of the present disclosure, the LO signals may differ in duty cycle (the percentage of one period in which the LO signal is high) and/or offset (the difference between start points of the period). In some aspects of the present disclosure, the LO signals may have a 25°/a duty cycle and a 50% offset. In some aspects of the present disclosure, each branch of the mixer circuitry (e.g., the in-phase (I) and quadrature phase (Q) path) may operate at a 25% duty cycle, which may result in a significant reduction is power consumption.

The RF input signal 207 (FIG. 2) may comprise a balanced signal, although the scope of the aspects of the present disclosure is not limited in this respect. The I and Q baseband output signals may be provided to low-nose amplifier, such as amplifier circuitry 306 (FIG. 3) or to filter circuitry 308 (FIG. 3).

In some aspects of the present disclosure, the output baseband signals 307 and the input baseband signals 311 may be analog baseband signals, although the scope of the aspects of the present disclosure is not limited in this respect. In some alternate aspects of the present disclosure, the output baseband signals 307 and the input baseband signals 311 may be digital baseband signals. In these alternate aspects of the present disclosure, the radio IC circuitry may include analog-to-digital converter (ADC) and digital-to-analog converter (DAC) circuitry.

In some dual-mode aspects of the present disclosure, a separate radio IC circuitry may be provided for processing signals for each spectrum, or for other spectrums not mentioned here, although the scope of the aspects of the present disclosure is not limited in this respect.

In some aspects of the present disclosure, the synthesizer circuitry 304 may be a fractional-N synthesizer or a fractional N/N+1 synthesizer, although the scope of the aspects of the present disclosure is not limited in this respect as other types of frequency synthesizers may be suitable. For example, synthesizer circuitry 304 may be a delta-sigma synthesizer, a frequency, multiplier, or a synthesizer comprising a phase-locked loop with a frequency divider. According to some aspects of the present disclosure, the synthesizer circuitry 304 may include digital synthesizer circuitry. An advantage of using a digital synthesizer circuitry is that, although it may still include some analog components, its footprint may be scaled down much more than the footprint of an analog synthesizer circuitry. In some aspects of the present disclosure, frequency input into synthesizer circuitry 304 may be provided by a voltage controlled oscillator (VCO), although that is not a requirement. A divider control input may further be provided by either the baseband processing circuitry 108 (FIG. 1) or the application processor 110 (FIG. 1) depending on the desired output frequency 305. In some aspects of the present disclosure, a divider control input (e.g., N) may be determined from a look-up table (e.g., within a Wi-Fi card) based on a channel number and a channel center frequency as determined or indicated by the application processor 110.

In some aspects of the present disclosure, synthesizer circuitry 304 may be configured to generate a carrier frequency as the output frequency 305, while in other aspects of the present disclosure, the output frequency 305 may be a fraction of the carrier frequency (e.g., one-half the carrier frequency, one-third the carrier frequency). In some aspects of the present disclosure, the output frequency 305 may be a LO frequency (fLO).

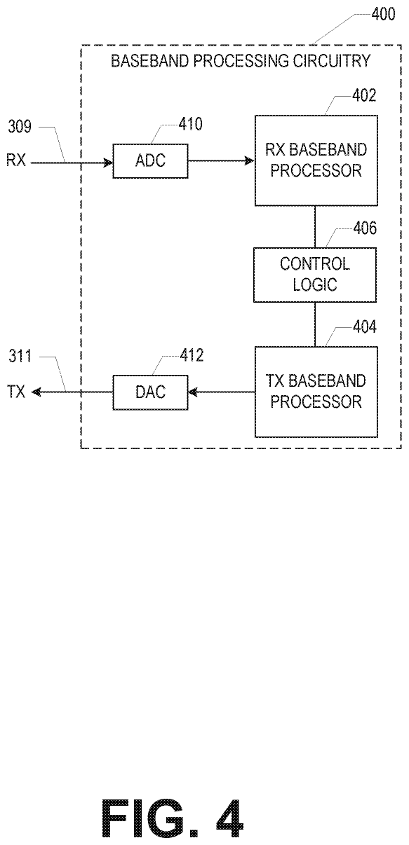

FIG. 4 illustrates a functional block diagram of baseband processing circuitry 400 in accordance with some aspects of the present disclosure. The baseband processing circuitry 400 is one example of circuitry that may be suitable for use as the baseband processing circuitry 108 (FIG. 1), although other circuitry configurations may also be suitable. The baseband processing circuitry 400 may include a receive baseband processor (RX BBP) 402 for processing receive baseband signals 309 provided by the radio IC circuitry 106 (FIG. 1) and a transmit baseband processor (TX BBP) 404 for generating transmit baseband signals 311 for the radio IC circuitry 106. The baseband processing circuitry 400 may also include control logic 406 for coordinating the operations of the baseband processing circuitry 400.

In some aspects of the present disclosure (e.g., when analog baseband signals are exchanged between the baseband processing circuitry 400 and the radio IC circuitry 106), the baseband processing circuitry 400 may include ADC 410 to convert analog baseband signals received from the radio IC circuitry 106 to digital baseband signals for processing by the RX BBP 402. In these aspects of the present disclosure, the baseband processing circuitry 400 may also include DAC 412 to convert digital baseband signals from the TX BBP 404 to analog baseband signals.

In some aspects of the present disclosure that communicate OFDM signals or OFDMA signals, such as through baseband processor 108A, the transmit baseband processor 404 may be configured to generate OFDM or OFDMA signals as appropriate for transmission by performing an inverse fast Fourier transform (IFFT). The receive baseband processor 402 may be configured to process received OFDM signals or OFDMA signals by performing an FFT. In some aspects of the present disclosure, the receive baseband processor 402 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 1, in some aspects of the present disclosure, the antennas 101A, 101B may each comprise one or more directional or omnidirectional antennas, including, for example, dipole antennas, monopole antennas, patch antennas, loop antennas, slot antennas or other types of antennas suitable for transmission of RF signals. In some multiple-input multiple-output (MIMO) aspects of the present disclosure, the antennas may be separated to take advantage of spatial/polarization diversity and the different channel characteristics that may result. Antennas 101A, 101B may each include a set of phased-array antennas, although aspects of the present disclosure are not so limited. Additionally, antennas 101A, 101B may each comprise transparent or non-transparent conductive material, suitable for portable device applications as described herein.

Although the radio-architecture 100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some aspects of the present disclosure, the functional elements may refer to one or more processes operating on one or more processing elements.

In some aspects, the radio architecture 100 can be associated with a wearable device, such as a smart watch or another computing device. In this case, one or more of the antennas 101A, 101B can be implemented using various techniques described herein. Typically, the antennas in some devices are hidden in a large bezel area surrounding the display, however, the bezel area becomes smaller and smaller and in some instances bezel-less implementations are possible. Current antennas are metallic-based and placed outside of the display area, which requires additional large bezel area. In some aspects described herein, transparent metallic conductor-based antenna designs can be used which integrate directly on the touch sensor, and feeding/radiation structures can be placed in the touch sensor routing areas around the perimeter of the display to improve total antenna performance. Solutions described herein can be used for implementing one or more antennas used in wearable devices or other types of devices with a small bezel display or bezel-less display. In some aspects, an antenna can be integrated into the display without compromising the touch sensitivity or the optical quality of the display.

FIG. 5 illustrates an example display stack-up in accordance with some aspects. Referring to FIG. 5, there is illustrated a display stack-up 500, which can be used in connection with a wearable device such as a smart watch. The display stack-up 500 can include multiple layers, such as a cover glass layer 502, a touch panel layer 506, and a display panel layer 512. The cover glass layer 502 can include one or more sub layers, such as a top sub-layer 503 and a bottom sub-layer 504. The touch panel layer 506 can include a sub-layer 508 with transmit (Tx) touch sensor traces and a sub-layer 510 with the receive (Rx) traces. The display panel layer 512 can include one or more layers of a liquid crystal display (LCD) or another type of display.

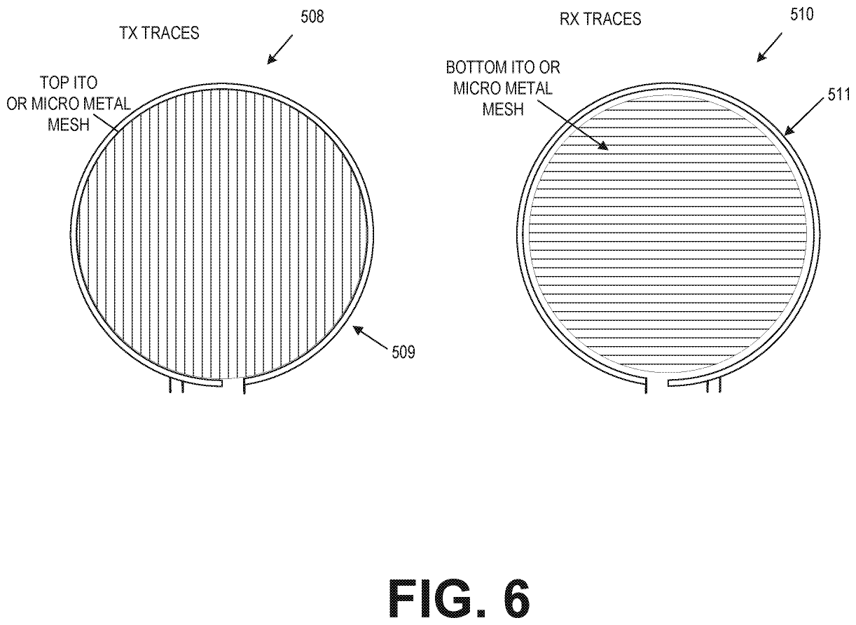

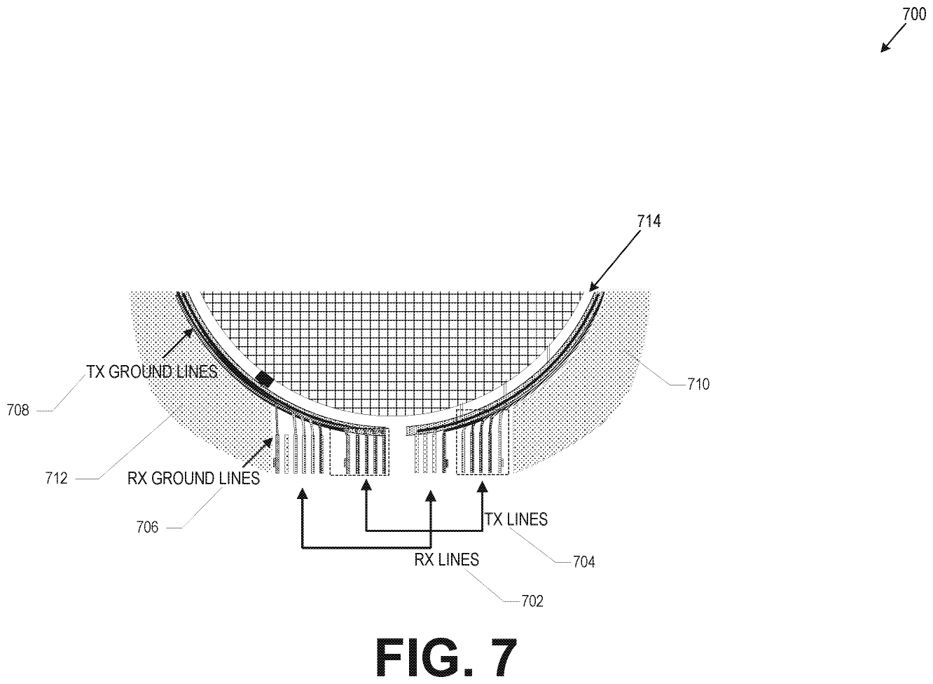

FIG. 6 illustrates touch sensor traces of a touch panel layer of a device display in accordance with some aspects. Referring to FIG. 6, there is illustrated a more detailed view of the top (TX) touch panel layer 508 and the bottom (Rx) touch panel layer 510 of FIG. 5. The touch panel sub-layers 508 and 510 can also include routing traces, referenced as 509 and 511 in FIG. 6. The touch panel traces 509 and 511 can partially or fully surround the touch panel and their shape can be based on the shape of the wearable device (e.g., circular, as seen in FIG. 6, rectangular or another type of shape). A more detailed diagram of the routing traces 509 and 511 is illustrated in FIG. 7.

In some aspects, the touch panel layers can be implemented using Indium tin oxide (ITO), micro metal mesh, or another technique.

FIG. 7 illustrates touch sensor traces of a touch panel layer in accordance with some aspects. Referring to FIG. 7, there is illustrated a more detailed view 700 of the touch panel routing traces for sub-layers 508 and 510. The routing traces can include the Rx lines 702 for the Rx sub-layer of the touch panel 506, the Tx lines 704 for the Tx sub-layer of the touch panel 506, TX ground lines 708, and RX ground lines 706.

In some aspects, one or more antenna structures can be disposed within available space, such as the space 714 between the transparent touch panel area and the routing traces. Additional areas where antenna structures can be disposed includes areas 710 and 712 disposed along the perimeter of the touch panel area and outside of the routing traces. The example antenna structures that can be disposed within those areas include one or more antenna radiation elements and one or more primary coupling feeding elements for improving antenna performance.

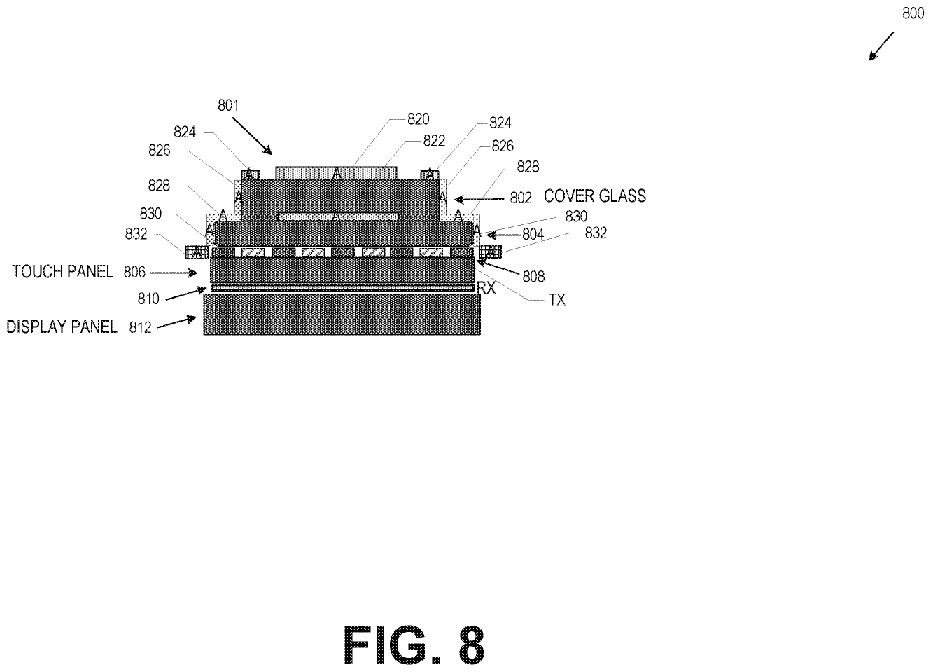

FIG. 8 illustrates a display stack-up with integrated antenna solutions in accordance with some aspects. Referring to FIG. 8, there is illustrated a cross-sectional view of a display stack-up 800, which can be similar to the display stack-up 500 of FIG. 5 and can include one or more antenna structures. The display stack-up 800 can include a cover glass layer 802 with sub-layers 801 and 804, a touch panel layer 806, and a display panel layer 812. The touch panel layer 806 can include sublayers

In some aspects, a display integratable hybrid antenna can be configured so that one or more antenna structures can be disposed within the display stack-up 800 associated with a computing device, such as a wearable device. For example, FIG. 8 illustrates the following example antenna structures (referenced with “A” in FIG. 8)—820, 822, 824, 826, 828, 830, and 832. In some aspects, antenna structures 820 and 822 can be transparent antennas implemented as antenna patches on surfaces of one or more sublayers of the cover glass 802 (e.g., sub-layers 801 or 804). In some aspects, antenna structures 824-832 are implemented as loops (with FIG. 8 illustrating a cross-sectional view of such loop antenna structures). In some aspects, visible or non-visible conductor materials can be used for the antenna structures 820-832, based on whether such antenna structures are located in a visible or non-visible (e.g., to a user) area of the wearable device implementing the stack-up 800.

In some aspects, the antenna structures within the stack-up 800 can include at least one primary coupling feeding structure and at least one generating structure. The generating structure can be coupled to the feeding structure, and in some aspects it can be alternating current (AC) coupled (inductively and/or capacitively coupled) to the feeding structure. The feeding structure can be coupled to a radio frequency processing module (or another transceiver circuitry module) via a feed line. The generating structure can be within a display area (and implemented via a transparent conductor) or within a non-visible area (and implemented via a non-transparent conductor). As used herein, the term “generating structure” can include a structure that is configured to generate RF signals. In this regard, the term “generating structure” can include a radiating structure configured to radiate RF signals. In some aspects, the term “generating structure” can also include a structure configured to receive RF signals.

In some aspects, one or more of the antenna structures 820, 822, 824, 826, 828, 830, and 832 can be configured as an antenna array and can be used in connection with one or more wireless bands.

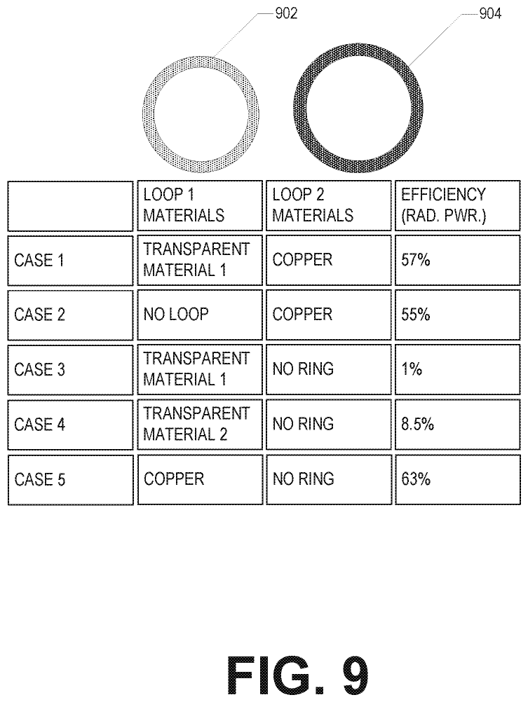

FIG. 9 illustrates example antenna feeding and generating structures in accordance with some aspects. Referring to FIG. 9, there is illustrated an example display area generating antenna structure 902 and a primary coupling feeding antenna structure 904, which can be used in connection with a display integratable hybrid transparent antenna for wearable devices or other types of computing devices. In some aspects, the generating structure 902 can be implemented using a transparent conductor and can be disposed within a visible area of the display stack-up 800. In some aspects, the primary coupling feeding structure 904 can be implemented using nontransparent conductive material (e.g., copper or another type of conductor), and can be disposed within nonvisible area of the stack-up 800, as discussed herein. In some aspects, the display area generating structure 902 and the primary coupling feeding structure 904 can be coplanar with each other, or can be orthogonal to each other. Additionally, structures 902 and 904 can be coupled to each other, such as the two structures can be capacitively and/or inductively coupled to each other.

In some aspects, the display area generating structure 902 and the primary coupling feeding structure 904 can be loops, as illustrated in FIG. 9, but other shapes can be used as well. For example, antenna structures 902 and 904 can be implemented as disks, patches, irregular shape loop, square shape, another rectangular, or hexagonal shape (with rounded off corners to reduce discontinuity and prevent creation of additional radiation), or slot shapes as a complementary structure. In some aspects, the circumference of the loops and/or the thickness of the loops used for implementing the structures 902 and 904 can be configured based on the desired antenna efficiency or communication band.

As seen in FIG. 9, five example cases are illustrated based on the materials for structures 902 and 904 and whether both structures or only a single structure (either structure 902 or 904) is utilized as an antenna. In some aspects and as listed for Case 1, the display area generating structure 902 can be implemented using a transparent (conductive) material and the primary coupling feeding structure 904 can be implemented via a non-transparent conductor, such as copper. In some aspects and as listed for Case 2, no display area generating structure 902 is used while the primary coupling feeding structure 904 can be implemented as an antenna via a non-transparent conductor, such as copper. In some aspects and as listed for Cases 3 and 4, no primary coupling feeding structure 904 is being used, while the display area generating structure 902 is implemented using different transparent (conductive) materials. In this case, structure 902 serves as the primary feeding structure. In some aspects and as listed for Case 5, the display area generating structure 902 can be implemented using a non-transparent conductor, such as copper, while no structure 904 is being used. In this case, structure 902 serves as the generating structure.

Even though five cases are illustrated as examples in FIG. 9 for different variations for the generating structure 902 and the feeding structure 904, the disclosure is not limited in this regard and other variations in the number and materials of the antenna structures are also possible. For example, in some aspects, multiple radiation antenna structures and multiple antenna feeding structure may be used (e.g., in connection with a multi-band wireless communication scheme for a device using the stack-up 800). In some aspects, a single antenna feeding structure may be used with multiple radiation structures. Additionally, each of the feeding and radiation structures can use different parts of the stack-up 800, as further clarified herein below.

As seen in FIG. 9, a high efficiency (e.g., radiation power efficiency) is achieved when the display area generating structure 902 is made of a transparent conductive material and the primary coupling feeding structure 904 is made up of nontransparent conductive material, with both structures being AC coupled to each other.

In some aspects, the display area generating structure can be made of a transparent conductor (e.g., ITO) and can be disposed on one or more layers of the display stack-up 800. For example and as illustrated in FIG. 8, the display area generating structure 820 can be disposed on top of the cover glass sublayers 801 (e.g., as a patch antenna). In some aspects, the display area generating structure 822 can be disposed on top of the cover glass sub-layer 804. In some aspects, the display area generating structure can be made of a transparent conductor and can be disposed on one or more layers of the stack-up 800 as a patch, or a circumference surrounding the cover glass shape, a circular loop (e.g., as seen in FIG. 9), a rectangular loop or part of segment for hybrid antenna designed which mixed with other structures in the 3D stack-up areas of a wearable device or another type of computing device with small bezel display or bezel-less display.

In some aspects, antenna structures can be implemented and nonvisible areas of the display stack-up 800, taking advantage of the material discontinuity between view area transparent conductor material and the edge touch trace routing area (e.g., areas 710, 712, and 714 in FIG. 7). For example, the primary coupling feeding structure 904 (or the generating structure 902) can be implemented as a loop 832 next to the touch trace routing area of the Tx layer 808 or within other non-used areas that are proximate to the touch sensor routing areas (and disposed in a plane that is above or below a plane with the touch sensor traces).

Similarly, the primary coupling feeding structure 904 (or the generating structure 902) can also be implemented as a loop that is coplanar with the Rx sub-layer 810.

In some aspects, the radiation/feeding structures can be incorporated into touch sensor routing areas surrounding the touch panel of a small bezel or bezel-less display device (e.g., a smart watch). In this regard, the unused bezel space needed for touch sensor routing can also incorporate the antenna structure to fit into this area with designed orientation and location.

In some aspects, hybrid antenna design concepts can reuse the stack-up area between display and watch chassis for either antenna radiation structures or feeding structures or coupling elements. In some aspects, all of these elements can be combined with a transparent conductor associated with one or more layers of the stack-up 800 to increase the radiated efficiency. For example, in some aspects, transparent conductors associated with the Tx sub-layer 808 or the Rx sub-layer 810 of the touch panel layer 806 can be used as the generating structure 902. Specific efficiency depends on the specific structure of the device, the feeding structure, coupling elements and generating elements, efficiencies showing FIG. 9 are representative of one example reference case.

In some aspects, antenna structures such as 826, 828, and 830 can be composed of nontransparent conductor (e.g. metal such as copper) and can be disposed in areas surrounding layers of the display stack-up 800. Additionally, in aspects when the antenna structure 820 or 822 is a display area generating structure, then the antenna structures 826 or 830 can be the primary coupling feeding structure which is orthogonal to the generating structure 820 or 822. The antenna structure 828 can be the primary coupling feeding structure which is coplanar with the generating structure 820 or 822.

In some aspects, for designs that require a large ground, the touch panel can be reused as the ground and coupling between antenna radiation structures and touch sensor traces to regain antenna performance, and with possible no-occupied dummy traces at the edge of display active view area. This hybrid design balances the transparent antenna performance, and reuses the large touch view areas for antenna designs for smaller bezels and smaller platforms.

In some aspects, the primary coupling feeding structure 904 can be implemented as a cylinder 826 surrounding one or more sublayers of the display stack-up 800 (e.g. surrounding cover glass 802 as illustrated in FIG. 8). In some aspects, the primary coupling feeding structure 904 can be implemented as a cylinder 830 surrounding the cover glass sub-layer 804. In some aspects, the primary coupling feeding structure 904 can be implemented as a loop 828 disposed on one or more sublayers of the display stack-up 800 (e.g., disposed on the cover glass sub-layer 804).

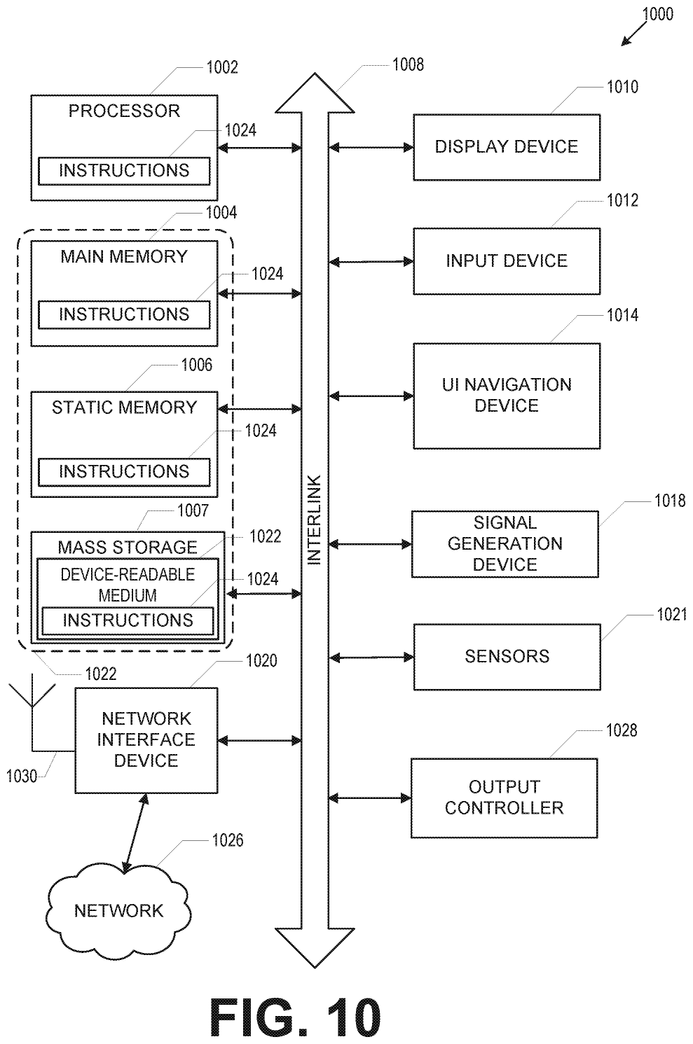

FIG. 10 illustrates a block diagram of a communication device in accordance with some aspects. In alternative aspects, the communication device 1000 may operate as a standalone device (e.g., as a wearable device or another smart computing device) or may be connected (e.g., networked) to other communication devices.

Circuitry (e.g., processing circuitry) is a collection of circuits implemented in tangible entities of the device 1000 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation.

In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the device 1000 follow.

In some aspects, the device 1000 may operate as a standalone device or may be connected (e.g., networked) to other devices. In a networked deployment, the communication device 1000 may operate in the capacity of a server communication device, a client communication device, or both in server-client network environments. In an example, the communication device 1000 may act as a peer communication device in peer-to-peer (P2P) (or other distributed) network environment. The communication device 1000 may be a UE, eNB, PC, a tablet PC, a STB, a PDA, a mobile telephone, a smart phone, a web appliance, a network router, switch or bridge, or any communication device capable of executing instructions (sequential or otherwise) that specify actions to be taken by that communication device. Further, while only a single communication device is illustrated, the term “communication device” shall also be taken to include any collection of communication devices that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a communication device-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Communication device (e.g., UE) 1000 may include a hardware processor 1002 (e.g., a central processing unit (CPU), a graphics processing unit (GPU), a hardware processor core, or any combination thereof), a main memory 1004, a static memory 1006, and mass storage 1016 (e.g., hard drive, tape drive, flash storage, or other block or storage devices), some or all of which may communicate with each other via an interlink (e.g., bus) 1008.

The communication device 1000 may further include a display unit 1010, an alphanumeric input device 1012 (e.g., a keyboard), and a user interface (UI) navigation device 1014 (e.g., a mouse). In an example, the display unit 1010, input device 1012 and UI navigation device 1014 may be a touch screen display. The communication device 1000 may additionally include a signal generation device 1018 (e.g., a speaker), a network interface device 1020, one or more antennas 1030, and one or more sensors 1021, such as a global positioning system (GPS) sensor, compass, accelerometer, or other sensor. The communication device 1000 may include an output controller 1028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some aspects, the one or more antennas 1030 can include display integratable antennas as disclosed herein in connection with FIG. 5-FIG. 9.

The storage device 1016 may include a communication device-readable medium 1022, on which is stored one or more sets of data structures or instructions 1024 (e.g., software) embodying or utilized by any one or more of the techniques or functions described herein. In some aspects, registers of the processor 1002, the main memory 1004, the static memory 1006, and/or the mass storage 1016 may be, or include (completely or at least partially), the device-readable medium 1022, on which is stored the one or more sets of data structures or instructions 1024, embodying or utilized by any one or more of the techniques or functions described herein. In an example, one or any combination of the hardware processor 1002, the main memory 1004, the static memory 1006, or the mass storage 1016 may constitute the device-readable medium 1022.

As used herein, the term “device-readable medium” is interchangeable with “computer-readable medium” or “machine-readable medium”. While the communication device-readable medium 1022 is illustrated as a single medium, the term “communication device-readable medium” may include a single medium or multiple media (e.g., a centralized or distributed database, and/or associated caches and servers) configured to store the one or more instructions 1024.

The term “communication device-readable medium” may include any medium that is capable of storing, encoding, or carrying instructions for execution by the communication device 1000 and that cause the communication device 1000 to perform any one or more of the techniques of the present disclosure, or that is capable of storing, encoding or carrying data structures used by or associated with such instructions. Non-limiting communication device-readable medium examples may include solid-state memories, and optical and magnetic media. Specific examples of communication device-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, communication device-readable media may include non-transitory communication device-readable media. In some examples, communication device-readable media may include communication device-readable media that is not a transitory propagating signal.

The instructions 1024 may further be transmitted or received over a communications network 1026 using a transmission medium via the network interface device 1020 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 1020 may include one or more physical jacks (e.g., Ethernet, coaxial, or phone jacks) or one or more antennas to connect to the communications network 1026. In an example, the network interface device 1020 may include a plurality of antennas to wirelessly communicate using at least one of single-input multiple-output (SIMO), MIMO, or multiple-input single-output (MISO) techniques. In some examples, the network interface device 1020 may wirelessly communicate using Multiple User MIMO techniques.

The term “transmission medium” shall be taken to include any intangible medium that is capable of storing, encoding or carrying instructions for execution by the communication device 1000, and includes digital or analog communications signals or other intangible medium to facilitate communication of such software. In this regard, a transmission medium in the context of this disclosure is a device-readable medium.

### Additional Notes and Examples

Example 1 is an apparatus for a computing device, the apparatus comprising: a radio front end module (RFEM) configured to generate radio frequency (RF) signals; a multi-layer display, comprising a liquid crystal display (LCD) layer, a touch panel layer, and a cover glass layer; and an antenna configured to transmit the RF signals, wherein the antenna comprises: a primary coupling feeding structure, configured to receive the RF signals from the radio front end module via a feed line; and a generating structure (e.g., a signal radiating structure) configured to radiate the RF signals, wherein the generating structure is alternating current (AC) coupled to the primary coupling feeding structure and is within a visible portion of the multi-layer display.

In Example 2, the subject matter of Example 1 includes, wherein the primary coupling feeding structure comprises a non-transparent material and is disposed in a non-visible area of the cover glass layer.

In Example 3, the subject matter of Examples 1-2 includes, wherein the primary coupling feeding structure comprises a non-transparent material and is disposed in a non-visible area of the touch panel layer.

In Example 4, the subject matter of Examples 1-3 includes, wherein the primary coupling feeding structure and the generating structure are co-planar with each other.

In Example 5, the subject matter of Examples 1-4 includes, wherein the primary coupling feeding structure and the generating structure are orthogonal to each other.

In Example 6, the subject matter of Examples 1-5 includes, wherein the primary coupling feeding structure and the generating structure comprise one of: a disc-shaped structure, a loop-shaped structure, a rectangular-shaped structure, a circle-shaped structure, a cylinder-shaped structure, and a hexagonal-shaped structure.

In Example 7, the subject matter of Examples 1-6 includes, wherein the primary coupling feeding structure comprises a non-transparent material surrounding one or more layers of the multi-layer display and positioned orthogonally to the generating structure.

In Example 8, the subject matter of Examples 1-7 includes, %.

In Example 9, the subject matter of Examples 1-8 includes, wherein cover glass layer comprises at least two sub-layers, and wherein the generating structure is disposed between the at least two sub-layers.

In Example 10, the subject matter of Examples 1-9 includes, wherein the generating structure is disposed on top of the cover glass layer.

In Example 11, the subject matter of Examples 1-10 includes, wherein the generating structure is a sublayer of the touch panel layer.

In Example 12, the subject matter of Example 11 includes, wherein the generating structure comprises a receive (Rx) sub-layer of the touch panel layer.

In Example 13, the subject matter of Examples 11-12 includes, wherein the generating structure comprises a transmit (Tx) sub-layer of the touch panel layer.

In Example 14, the subject matter of Examples 1-13 includes, wherein the generating structure comprises a transparent material disposed within one of the layers of the multi-layer display.

Example 15 is a display integratable antenna of a computing device with a predominant display feature, the antenna comprising: a primary coupling feeding structure, the feeding structure comprising a non-transparent material and configured to receive radio frequency (RF) signals; and a generating structure, the generating structure alternating current (AC) coupled to the primary coupling feeding structure and configured to radiate the RF signals, wherein: the generating structure comprises a transparent material disposed within a visible area of a multi-layer display panel, the primary coupling feeding structure comprises a non-transparent material disposed within a non-visible area of the multi-layer display panel, and the generating structure is one of orthogonal or co-planar with the primary coupling feeding structure.

In Example 16, the subject matter of Example 15 includes, wherein the generating structure comprises a transparent patch antenna are within a cover glass layer of the touch-enabled display.

In Example 17, the subject matter of Examples 15-16 includes, wherein the non-transparent material of the primary coupling feeding structure comprises a metal conductor loop within a touch panel traces area of the touch-enabled display.

Example 18 is an antenna structure comprising: a radio frequency integrated circuit configured to process radio frequency (RF) signals in multiple wireless bands; a first feeding antenna structure, the first feeding antenna structure comprising a first non-transparent material and configured to transmit or receive a subset of the RF signals in a first wireless band of the multiple wireless bands; a second feeding antenna structure, the second feeding antenna structure comprising a second non-transparent material and configured to transmit or receive another subset of the RF signals in a second wireless band of the multiple wireless bands; and a generating structure, the generating structure comprising a transparent conductive material and alternating current (AC) coupled to the first and second feeding antenna structures to radiate the RF signals.

In Example 19, the subject matter of Example 18 includes, wherein the first and second feeding antenna structures are integrated within different layers of a multi-layer display panel.

In Example 20, the subject matter of Examples 18-19 includes, wherein one or both of the first feeding antenna structure and the second feeding antenna structure comprise a wireless antenna array.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Although an aspect has been described with reference to specific example aspects, it will be evident that various modifications and changes may be made to these aspects without departing from the broader scope of the present disclosure. Accordingly, the specification and drawings are to be regarded in an illustrative rather than a restrictive sense. The accompanying drawings that form a part hereof show, by way of illustration, and not of limitation, specific aspects in which the subject matter may be practiced. The aspects illustrated are described in sufficient detail to enable those skilled in the art to practice the teachings disclosed herein. Other aspects may be utilized and derived therefrom, such that structural and logical substitutions and changes may be made without departing from the scope of this disclosure. This Detailed Description, therefore, is not to be taken in a limiting sense, and the scope of various aspects is defined only by the appended claims, along with the full range of equivalents to which such claims are entitled.

Such aspects of the inventive subject matter may be referred to herein, individually or collectively, merely for convenience and without intending to voluntarily limit the scope of this application to any single aspect or inventive concept if more than one is in fact disclosed. Thus, although specific aspects have been illustrated and described herein, it should be appreciated that any arrangement calculated to achieve the same purpose may be substituted for the specific aspects shown. This disclosure is intended to cover any and all adaptations or variations of various aspects. Combinations of the above aspects, and other aspects not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single aspect for the purpose of streamlining the disclosure. This method of disclosure is not to be interpreted as reflecting an intention that the claimed aspects require more features than are expressly recited in each claim. Rather, as the following claims reflect, inventive subject matter lies in less than all features of a single disclosed aspect. Thus the following claims are hereby incorporated into the Detailed Description, with each claim standing on its own as a separate aspect.

1. An apparatus for use with a mobile device, the apparatus comprising:
a radio front end module (RFEM) configured to generate radio frequency (RF) signals;
a multi-layer display, comprising a liquid crystal display (LCD) layer, a touch panel layer, and a cover glass layer; and
an antenna configured to transmit the RF signals, wherein the antenna comprises:
a primary coupling feeding structure, configured to receive the RF signals from the radio front end module via a feed line; and
a generating structure configured to generate the RF signals, wherein the generating structure is alternating current (AC) operably coupled to the primary coupling feeding structure display.

2. The apparatus of claim 1, wherein the primary coupling feeding structure comprises a non-transparent material and is disposed in a non-visible area of the cover glass layer.

3. The apparatus of claim 1, wherein the primary coupling feeding structure comprises a non-transparent material and is disposed in a non-visible area of the touch panel layer.

4. The apparatus of any of claim 1, wherein the primary coupling feeding structure and the generating structure are co-planar with each other or orthogonal to each other.

5. The apparatus of claim 1, wherein the generating structure is within a predetermined distance from the multi-layer display.

6. The apparatus of any of claim 1, wherein the primary coupling feeding structure and the generating structure comprise one of:
a disc-shaped structure,
a loop-shaped structure,
a rectangular-shaped structure,
a circle-shaped structure,
a cylinder-shaped structure, and
a hexagonal-shaped structure.

7. The apparatus of claim 1, wherein the primary coupling feeding structure comprises a non-transparent material surrounding one or more layers of the multi-layer display and positioned orthogonally to the generating structure.

8. The apparatus of claim 1, wherein the generating structure comprises Indium Tin Oxide (ITO) or another conductive material with transparency of at least 80%.

9. The apparatus of claim 1, wherein the cover glass layer comprises at least two sub-layers, and wherein the generating structure is disposed between the at least two sub-layers.

10. The apparatus of any of claim 1, wherein the generating structure is disposed on top of the cover glass layer.

11. The apparatus of claim 1, wherein the generating structure is a sublayer of the touch panel layer.

12. The apparatus of claim 11, wherein the generating structure comprises a receive (Rx) sub-layer of the touch panel layer.

13. The apparatus of claim 11, wherein the generating structure comprises a transmit (Tx) sub-layer of the touch panel layer.

14. The apparatus of claim 1, wherein the generating structure comprises a transparent material disposed within one of the layers of the multi-layer display.

15. A display integratable antenna of a computing device with a predominant display feature, the antenna comprising:
a primary coupling feeding structure, configured to receive radio frequency (RF) signals; and
a generating structure, the generating structure alternating current (AC) operably coupled to the primary coupling feeding structure and configured to radiate the RF signals, wherein:
the generating structure comprises a transparent material disposed within a visible area of a multi-layer display panel,
the primary coupling feeding structure comprises a non-transparent material disposed within a non-visible area of the multi-layer display panel, and
the generating structure is one of orthogonal or co-planar with the primary coupling feeding structure.

16. The display integratable antenna of claim 15, wherein the generating structure comprises a transparent patch antenna within a cover glass layer of a touch-enabled display.

17. The display integratable antenna of any of claim 15, wherein the non-transparent material of the primary coupling feeding structure comprises a metal conductor loop within a touch panel traces area of the touch-enabled display.

18. An antenna structure comprising:
a radio frequency integrated circuit configured to process radio frequency (RF) signals in multiple wireless bands;
a first feeding antenna structure, the first feeding antenna structure comprising a first non-transparent material and configured to transmit or receive a subset of the RF signals in a first wireless band of the multiple wireless bands;
a second feeding antenna structure, the second feeding antenna structure comprising a second non-transparent material and configured to transmit or receive another subset of the RF signals in a second wireless band of the multiple wireless bands; and
a generating structure, the generating structure comprising a transparent conductive material and alternating current (AC) operably coupled to the first and second feeding antenna structures to radiate the RF signals.

19. The antenna structure of claim 18, wherein the first and second feeding antenna structures are integrated within different layers of a multi-layer display panel.

20. The antenna structure of claim 18, wherein one or both of the first feeding antenna structure and the second feeding antenna structure comprise a wireless antenna array.
